(19) United States
(12) Patent Application Publication
(10) Pub. No.: US 2026/0078306 A1
(43) Pub. Date: Mar. 19, 2026

(54) METHODS FOR PROCESSING PLASTIC-DERIVED OILS AND WASTE PLASTICS

(71) Applicant: Saudi Arabian Oil Company, Dhahran (SA)

(72) Inventor: Aaron Chi Akah, Dhahran (SA)

(73) Assignee: Saudi Arabian Oil Company, Dhahran (SA)

(21) Appl. No.: 18/888,998

(22) Filed: Sep. 18, 2024

(51) Int. Cl. C10G 11/05; B01J 23/10; B01J 23/745; B01J 27/16; B01J 29/76; B01J 35/45; C10G 11/18

(52) U.S. Cl. CPC C10G 11/05; B01J 23/10; B01J 23/745; B01J 27/16; B01J 29/7615; B01J 35/45; C10G 11/18; B01J 2229/42; B01J 2523/3706; B01J 2523/3712; B01J 2523/842; C10G 2300/1003; C10G 2400/20

(57) ABSTRACT

A method for processing a plastic-derived oil may comprise contacting the plastic-derived oil with a catalyst to crack the plastic-derived oil to form a hydrocarbon product. The catalyst may comprise a metal oxide-loaded zeolite Beta comprising: zeolite Beta particles having a size of less than 100 nm, and one or more metal oxides chosen from iron oxide, lanthanum oxide, and cerium oxide. The one or more metal oxides may be disposed on the zeolite Beta particles.

### TECHNICAL FIELD

Embodiments of the present disclosure generally relate to chemical processing and, more specifically, to methods and systems utilized in the processing of plastic-derived oils and waste plastics.

### BACKGROUND

The use of plastics in commercial and industrial application has become prolific. The increasing use of plastics worldwide has increased the generation of waste plastic, which presents a sustainability opportunity. Plastic is a synthetic or semisynthetic organic polymer composed of mainly carbon and hydrogen. Further, plastics tend to be durable, with a slow rate of degradation, therefore they stay in the environment for a long time and are not prone to rapid breakdown upon disposal. Overabundance of plastic waste is a growing problem worldwide, and conversion and/or recycling of plastic waste into higher-value chemicals and/or fuels can be beneficial both from an environmental and commodity chemical production point of view.

### BRIEF SUMMARY

Embodiments of the present disclosure provide, according to one or more embodiments, methods of processing plastic-derived oil and/or waste plastic that can be formed into plastic-derived oil. According to embodiments, a catalyst is presently disclosed that promotes conversion of the plastic-derived oil into higher-value chemicals, such as propylene and/or butenes. Such catalysts include metal oxide-loaded zeolite Beta, as described herein.

According to one or more embodiments, a method for processing a plastic-derived oil, the method comprising: contacting the plastic-derived oil with a catalyst to crack the plastic-derived oil to form a hydrocarbon product, wherein: the catalyst comprises metal oxide-loaded zeolite Beta comprising: zeolite Beta particles having a size of less than 100 nm; and one or more metal oxides chosen from iron oxide, lanthanum oxide, and cerium oxide, wherein the one or more metal oxides are disposed on the zeolite Beta particles.

According to one or more additional embodiments, a method for processing waste plastic, the method comprising: producing plastic-derived oil from the waste plastic; and contacting the plastic-derived oil with a catalyst to form a hydrocarbon product, wherein the catalyst comprises metal oxide-loaded zeolite Beta comprising: zeolite Beta particles having a size of less than 100 nm; and one or more metal oxides chosen from iron oxide, lanthanum oxide, and cerium oxide, wherein the one or more metal oxides are disposed on the zeolite Beta particles.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a generalized schematic diagram of an embodiment of a fluid catalytic cracking reactor unit, according to one or more embodiments described in this disclosure; and

FIG. 2 depicts a generalized schematic diagram of system for converting waste plastics into plastic-derived oil, according to one or more embodiments described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

One or more embodiments of the present disclosure relate to methods for processing plastic-derived oil. Additional embodiments of the present disclosure related to processing waste plastics by processing the waste plastics into plastic-derived oils and then processing such plastic-derived oils into hydrocarbon products. Such hydrocarbon products may include light olefins such as propylene and butene. Generally, the plastic-derived oil may be contacted with a catalyst to form the hydrocarbon product, where the catalyst presently described may be specialized for promoting conversation of the plastic-derived oil into products that have relative high amounts of light olefins.

According to embodiments described herein, the catalyst utilized in the presently disclosed methods may include metal oxide-loaded zeolite Beta. Such metal oxide-loaded zeolite Beta may comprise zeolite Beta particles having a size of less than 100 nm (sometimes referred to herein as “nano-sized” zeolite Beta), and metal oxides disposed on the zeolite Beta particles. According to some embodiments, the metal oxide-loaded zeolite Beta may include iron oxide, lanthanum oxide, and cerium oxide. Without intending to be bound by any particular theory, it is believed that utilizing a catalyst comprising the metal oxide-loaded zeolite Beta that comprises iron oxide may improve selectivity of light olefins and/or increase catalyst stability. Further it is believed that when utilizing a catalyst comprising the metal oxide-loaded zeolite Beta that comprises lanthanum oxide and/or cerium oxide, the lanthanum oxide and/or cerium oxide may function as a vanadium trap, which may increase catalyst stability.

As described in this disclosure, a “catalyst” refers to any substance which increases the rate of a specific chemical reaction. Catalysts described in this disclosure may be utilized to promote various reactions, such as, but not limited to, cracking of plastic-derived oils, such as by fluidized catalytic cracking (FCC).

As used in this disclosure, the terms “butenes” and “mixed butenes” refers to 1-butene, cis-2-butene, trans-2-butene, isobutene, and combinations of these. As used in this disclosure, the term “normal butenes” refers to 1-butene, cis-2-butene, trans-2-butene, and any combination thereof, but not including isobutene.

According to one or more embodiments, a method for processing a plastic-derived oil may comprise contacting a plastic-derived oil with a catalyst to form a hydrocarbon product. The catalyst is fluidized while contacting the plastic-derived oil. For example, the catalyst may be contacted with the plastic-derived oil in a fluid catalytic cracking (“FCC”) reactor unit operating at elevated temperature, such as from 600° C. to 700° C.

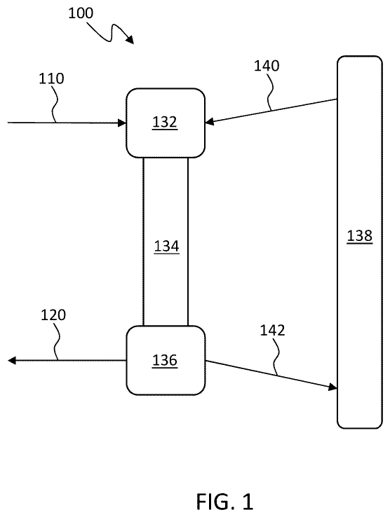

Embodiments of presently described methods are now described in the context of an FCC reactor system. However, other reactor types are contemplated as being suitable for the methods described herein to process plastic-derived oils. Now referring to FIG. 1, according to one or more embodiments, the reactor unit used to process the plastic-derived oil may be an FCC reactor unit 100. As used in this disclosure, a “fluid catalytic cracking reactor unit” refers to a reactor unit that can be operable to contact a fluidized reactant with a solid material (usually in particulate form), such as a cracking catalyst. As described in this disclosure, a fluidized bed reactor which cracks a reactant stream (such as plastic-derived oil) with a fluidized solid cracking catalyst may be referred to as a fluid catalytic cracking reactor unit.

FIG. 1 schematically depicts a fluid catalytic cracking reactor unit 100 which converts a plastic-derived oil 110 into a hydrocarbon product 120. The embodiment of FIG. 1 includes cracking catalyst regeneration functionality.

Still referring to FIG. 1, the plastic-derived oil 110 may be passed to a fluid catalytic cracking reactor unit 100. The fluid catalytic cracking reactor unit 100 may include a cracking catalyst/feed mixing zone 132, a reaction zone 134, a separation zone 136, and a cracking catalyst regeneration zone 138. The plastic-derived oil 110 may be introduced to the cracking catalyst/feed mixing zone 132 where it is mixed with regenerated cracking catalyst from regenerated catalyst stream 140 passed from the cracking catalyst regeneration zone 138. The plastic-derived oil 110 is reacted by contact with the regenerated cracking catalyst in the reaction zone 134, which cracks the contents of the plastic-derived oil 110. Following the cracking reaction in the reaction zone 134, the contents of the reaction zone 134 are passed to the separation zone 136 where the cracked product of the reaction zone 134 is separated from spent catalyst, which is passed in a spent catalyst stream 142 to the cracking catalyst regeneration zone 138 where it is regenerated by, for example, removing coke from the spent cracking catalyst if coke was created in the reaction. Alternatively, if little or no coke is created, the regeneration process may comprise heating the catalyst by, for example, burning a combustible fuel. The hydrocarbon product 120 is passed from the fluid catalytic cracking reactor unit, where it may be further processed, for example by separation into multiple streams.

It should be understood that fluid catalytic cracking reactor unit 100 of FIG. 1 is a simplified schematic of one particular embodiment of a fluid catalytic cracking reactor unit, and other configurations of fluid catalytic cracking reactor units may be suitable for the presently disclosed hydrocarbon cracking methods. For example, in some embodiments, the catalyst may not be recycled, and in such embodiments, the components of FIG. 1 related to the regeneration of the cracking catalyst would not be present.

As described herein, according to one or more embodiments, a plastic-derived oil 110 is utilized as the feed to the fluid catalytic cracking reactor unit 100. As described herein, “plastic-derived oil” refers to any oil (i.e., a primarily liquid hydrocarbon mixture) that is primarily produced from plastic, such as waste plastic. That is, plastic derived oil, as described herein, refers to oils that include a majority of constituents on a weight basis that are derived from waste plastics. It should be understood that plastic-derived oils, as described herein, may have amounts of non-plastic-derived hydrocarbons, such as less than 50 wt. %, less than 30 wt. %, or less than 10 wt. %. In some embodiments, the entirety of the plastic-derived oil is oil that is produced from waste plastic.

The plastic-derived oil 110 may be a liquid stream comprising hydrocarbons and produced through melting, dehalogenation, and pyrolysis of solid waste plastics. As previously discussed, the plastic-derived oil 110 may include hydrocarbons, such as but not limited to aromatic compounds, olefins, alkanes, or other hydrocarbon compounds.

In one or more embodiments, the plastic-derived oil 110 may comprise light naphtha, jet fuel, diesel, heavy compounds, or combinations of these. As described herein, light naphtha refers to hydrocarbons having atmospheric boiling point temperatures of from 25° C. to 150° C., jet fuel refers to hydrocarbons having atmospheric boiling point temperatures of from 150° C. to 300° C., diesel refers to hydrocarbons having atmospheric boiling point temperatures of from 300° C. to 343° C., and the heavy compounds refer to hydrocarbons having atmospheric boiling point temperatures of greater than 343° C.

In some embodiments, the plastic-derived oil 110 may comprise from 5 wt. % to 50 wt. % hydrocarbons having a boiling point of less than 150° C. (i.e., light naphtha), such as from 20 wt. % to 30 wt. % hydrocarbons having a boiling point of less than 150° C., or any combination of the ranges of from 5 wt. % to 10 wt. %, from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. % of hydrocarbons having a boiling point of less than 150° C.

In some embodiments, the plastic-derived oil 110 may comprise from 25 wt. % to 75 wt. % of hydrocarbons having a boiling point of from 150° C. to 300° C. (i.e., jet fuel), such as from 45 wt. % to 55 wt. % of hydrocarbons having a boiling point of from 150° C. to 300° C., or any combination of the ranges of from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. % of hydrocarbons having a boiling point of from 150° C. to 300° C.

In some embodiments, the plastic-derived oil 110 may comprise from 5 wt. % to 30 wt. % of hydrocarbons having a boiling point of from 300° C. to 343° C. (i.e., diesel), such as from 10 wt. % to 20 wt. % of hydrocarbons having a boiling point of from 300° C. to 343° C., or any combination of the ranges of from 5 wt. % to 10 wt. %, from 10 wt. % to 15 wt. %, from 15 wt. % to 20 wt. %, from 20 wt. % to 25 wt. %, or from 25 wt. % to 30 wt. % of hydrocarbons having a boiling point of from 300° C. to 343° C.

In some embodiments, the plastic-derived oil 110 may comprise from 0 wt. % to 25 wt. % of hydrocarbons having a boiling point of greater than 343° C. (i.e., heavy compounds), such as from 5 wt. % to 15 wt. % of hydrocarbons having a boiling point of from 150° C. to 300° C., or any combination of the ranges of from 0 wt. % to 5 wt. %, from 5 wt. % to 10 wt. %, from 10 wt. % to 15 wt. %, from 15 wt. % to 20 wt. %, or from 20 wt. % to 25 wt. % of hydrocarbons having a boiling point of greater than 343° C.

The plastic-derived oil 110 may be characterized by a boiling point distribution determined using standard test method ASTM D2887. In one or more embodiments, the plastic-derived oil 110 may have an initial boiling point (IBP) of from 20° C. to 100° C., such as from 20° C. to 60° C., from 20° C. to 50° C., from 25° C. to 100° C. from 25° C. to 60° C., from 25° C. to 50° C., or from 25° C. to 40° C. In one or more embodiments, the plastic-derived oil 110 may have a final boiling point (FBP) of from 300° C. to 600° C., such as from 300° C. to 500° C., from 300° C. to 450° C., from 350 to 600° C., from 350° C. to 500° C., from 350° C. to 450° C., or from 375° C. to 425° C. In one or more embodiments, the plastic-derived oil 110 may have a 50% boiling point temperature of from 150° C. to 350° C., such as from 150° C. to 300° C., from 150° C. to 275° C., from 200° C. to 350° C., from 200° C. to 300° C., from 200° C. to 275° C., from 225° C. to 350° C., from 225° C. to 300° C., or from 225° C. to 275° C., where the 50% boiling point temperature is the temperature in the boiling point distribution at which 50 wt. % of the constituents of the plastic-derived oil 110 have transitioned from the liquid phase into the vapor phase.

In one or more embodiments, the plastic-derived oil 110 may have a density of from 0.65 g/ml to 1.1 g/ml, such as from 0.65 g/ml to 1.0 g/ml, from 0.65 g/ml to 0.9 g/ml, from 0.65 g/ml to 0.8 g/ml, from 0.7 g/ml to 1.1 g/ml, from 0.7 g/ml to 1.0 g/ml, from 0.7 g/ml to 0.9 g/ml, from 0.7 g/ml to 0.8 g/ml, from 0.75 g/ml to 1.1 g/ml, from 0.75 g/ml to 1.0 g/ml, from 0.75 g/ml to 0.9 g/ml, or from 0.75 g/ml to 0.85 g/ml, as determined by ASTM D4052. In one or more embodiments, the plastic-derived oil 110 may have less than or equal to 0.1 wt. % sulfur, as determined by ASTM D4294. In one or more embodiments, the plastic-derived oil 110 may have less than 0.01 wt. % Conradson carbon, as determined according to ASTM D4530. In one or more embodiments, the plastic-derived oil 110 may have an oxygen content of from 100 ppmw to 10,000 ppmw, such as from 100 ppmw to 7,000 ppmw, from 500 ppmw to 10,000 ppmw, from 500 ppmw to 7000 ppmw, from 1000 to 10,000 ppmw, from 1000 to 7000 ppmw, or from 5000 ppm to 10,000 ppmw. In one or more embodiments, the plastic-derived oil 110 may have a moisture content (concentration of water) of less than or equal to 5000 ppmw, less than or equal to 2000 ppmw, less than or equal to 1000 ppmw, less than or equal to 500 ppmw, or less than or equal to 400 ppmw, as determined according to ASTM D6304A. In one or more embodiments, the plastic-derived oil 110 may have the properties provided in Table 1.

TABLE 1
Properties of one embodiment of the plastic-derived oil 110

| Property | Units | Test Method | Value |
|---|---|---|---|
| Density | g/mL | ASTM D4052 | 0.792 |
| Total Oxygen | ppmw | Combustion based | 5540 |
| Concentration | | | |
| Total Chloride | ppmw | UOP 779 | 342 |
| Concentration | | | |
| Total Sulfur | wt. % | ASTM D4294 | 0.064 |
| Total Nitrogen | ppmw | ASTM D4629 | 1135 |
| Bromine Number | g(Br₂)/100 g | ASTM D1159 | 43.3 |
| Silica | ppmw | UOP 407 | 0.109 |
| Sodium | ppmw | UOP 407 | 0.174 |
| Iron | ppmw | UOP 407 | 0.097 |
| Water | ppmw | ASTM D6304A | 299 |
| Conradson Carbon | wt. % | ASTM D4530 | <0.01 |
| Residue | | | |

Simulated Distillation Table

| Recovery (wt. %) | Units | Test Method | Temperature |
|---|---|---|---|
| SIMDIST - IBP | ° C. | ASTM D2887 | 29.4 |
| SIMDIST - 5 wt. % | ° C. | ASTM D2887 | 77.7 |
| SIMDIST - 10 wt. % | ° C. | ASTM D2887 | 107.1 |
| SIMDIST - 15 wt. % | ° C. | ASTM D2887 | 127.3 |
| SIMDIST - 20 wt. % | ° C. | ASTM D2887 | 139.9 |
| SIMDIST - 25 wt. % | ° C. | ASTM D2887 | 158.7 |
| SIMDIST - 30 wt. % | ° C. | ASTM D2887 | 173.6 |
| SIMDIST - 35 wt. % | ° C. | ASTM D2887 | 188.7 |
| SIMDIST - 40 wt. % | ° C. | ASTM D2887 | 207.9 |
| SIMDIST - 45 wt. % | ° C. | ASTM D2887 | 225.6 |
| SIMDIST - 50 wt. % | ° C. | ASTM D2887 | 240.0 |
| SIMDIST - 55 wt. % | ° C. | ASTM D2887 | 253.9 |
| SIMDIST - 60 wt. % | ° C. | ASTM D2887 | 266.2 |
| SIMDIST - 65 wt. % | ° C. | ASTM D2887 | 279.3 |
| SIMDIST - 70 wt. % | ° C. | ASTM D2887 | 293.8 |
| SIMDIST - 75 wt. % | ° C. | ASTM D2887 | 307.1 |
| SIMDIST - 80 wt. % | ° C. | ASTM D2887 | 320.2 |
| SIMDIST - 85 wt. % | ° C. | ASTM D2887 | 333.7 |
| SIMDIST - 90 wt. % | ° C. | ASTM D2887 | 347.8 |
| SIMDIST - 95 wt. % | ° C. | ASTM D2887 | 364.7 |
| SIMDIST - FBP | ° C. | ASTM D2887 | 405.3 |

As described herein, the plastic-derived oil 110 is contacted by the catalyst to from the hydrocarbon product 120. According to embodiments, the catalyst may comprise a metal oxide-loaded zeolite Beta, where the metal oxide-loaded zeolite Beta comprises zeolite Beta particles having a size of less than 100 nm and one or more metal oxides chosen from iron oxide, lanthanum oxide, and cerium oxide, where the metal oxides are disposed on the zeolite Beta particles.

As used throughout this disclosure, and as would be understood by those skilled in the art, “zeolites” may refer to micropore-containing inorganic materials with regular intra-crystalline cavities and channels of molecular dimension. As is understood by those skilled in the art, and as used in this disclosure, “zeolite Beta” refers to a type of zeolite having a *BEA framework type according to the International Zeolite Association (“IZA”) zeolite nomenclature and consisting majorly of silica and alumina. The molar ratio of silica to alumina in the zeolite Beta may be 5 or greater, 10 or greater, 25 or greater, or even 100 or greater. For example, the molar ratio of silica to alumina in the zeolite Beta may be from 5 to 500, such as from 10 to 50. Silica to Alumina ratio can be measured by X-ray Fluorescence (“XRF”) spectrometry, as would be understood by those skilled in the art.

Zeolites generally comprise a crystalline structure, as opposed to an amorphous structure such as what may be observed in some porous materials such as amorphous silica. Zeolites generally include a microporous framework which may be identified by a framework type. The microporous structure of zeolites (e.g., 0.3 nm to 2 nm pore size) may render large surface areas and desirable size-/shape-selectivity, which may be advantageous for catalysis. The average pore size, which is how pore sized is characterized herein unless stated otherwise, may be determined by Brunauer-Emmett-Teller (BET) analysis, which is a classification technique that is well understood by those skilled in the art.

As described herein, “nano-sized” refers to zeolitic particles and/or crystals that have an average particle size of less than or equal to 100 nm, where the average is utilized to classify size since the zeolitic particles, when produced, are generally dispersed in size in a distribution, such as a normal distribution. In some embodiments, the metal oxide-loaded zeolite Beta may have an average particle size ranging from 10 to 100 nm, such as from 20 nm to 100 nm, from 30 nm to 100 nm, from 40 nm to 100 nm, from 50 nm to 100 nm, from 60 nm to 100 nm, from 70 nm to 100 nm, from 80 nm to 100 nm, from 90 nm to 100 nm, from 10 nm to 80 nm, from 10 nm to 70 nm, from 10 nm to 60 nm, from 10 nm to 50 nm, from 10 nm to 40 nm, from 10 nm to 30 nm, or from 10 nm to 20 nm. The metal oxide-loaded zeolite Beta described herein may form as particles that may be generally spherical in shape or irregular globular shaped (that is, non-spherical). In embodiments, the particles have a “particle size” measured as the greatest distance between two points located on a single zeolite particle. For example, the particle size of a spherical particle is equal to its diameter. In other shapes, the particle size is measured as the distance between the two most distant points of the same particle, where these points may lie on outer surfaces of the particle. Average particle size can be determined using Scanning Electron Microscopy (“SEM”), where the particle size is measured as the longest distance in any dimension of a particle.

Without being bound by theory, it is believed that the relatively small particle size allows for easier access by the molecules in the plastic-derived oil to active sites on the zeolite. For example, the increased external surface area may be caused by the small particle size, which may increase catalytic activity.

According to one or more embodiments, the metal oxide-loaded zeolite Beta may have a pore volume of from 0.5 to 2.0 mL/g. For example, embodiments of the metal oxide-loaded zeolite Beta may have a pore volume of from 0.5 to 0.6 mL/g, from 0.5 to 0.7 mL/g, from 0.5 to 0.8 mL/g, from 0.5 to 0.9 mL/g, from 0.5 to 1.0 mL/g, from 0.5 to 1.1 mL/g, from 0.5 to 1.2 mL/g, from 0.5 to 1.3 mL/g, from 0.5 to 1.4 mL/g, from 0.5 to 1.5 mL/g, from 0.7 to 0.6 mL/g, from 0.5 to 0.7 mL/g, from 0.7 to 0.8 mL/g, from 0.7 to 0.9 mL/g, from 0.7 to 1.0 mL/g, from 0.7 to 1.1 mL/g, from 0.7 to 1.2 mL/g, from 0.7 to 1.3 mL/g, from 0.7 to 1.4 mL/g, or from 0.7 to 1.5 mL/g. As used in this disclosure, “pore volume” refers to the total pore volume measured. The pore volume may be determined by Brunauer-Emmett-Teller (BET) analysis, which is a classification technique that is well understood by those skilled in the art.

According to one or more embodiments, the metal oxide-loaded zeolite Beta may have a surface area of from 500 m²/g to 800 m²/g. For example, embodiments of the metal oxide-loaded zeolite Beta may have a surface area of from 500 m²/g to 550 m²/g, from 500 m²/g to 600 m²/g, from 500 m²/g to 650 m²/g, from 550 m²/g to 700 m²/g, from 550 m²/g to 750 m²/g, from 550 m²/g to 800 m²/g, from 600 m²/g to 800 m²/g, from 600 m²/g to 750 m²/g, from 600 m²/g to 700 m²/g, or from 650 m²/g to 700 m²/g. The surface area may be determined by Brunauer-Emmett-Teller (BET) analysis, which is a classification technique that is well understood by those skilled in the art.

The presently described metal oxide-loaded zeolite Beta may be produced by a process which comprises several fabrication steps which may include forming or other wise providing zeolite Beta. Methods of forming the zeolite Beta are described in “Effect of agitation on the synthesis of zeolite beta and its synthesis mechanism in absence of alkali cations”, Microporous and Mesoporous Materials, 2008, vol. 94, pgs. 1-8, the entirety of which is incorporated by reference herein. Methods of producing the metal oxide-loaded zeolite Beta may further comprise contacting the zeolite Beta with one or more metal oxide precursors to impregnate one or more metal oxides in the zeolite Beta, and subsequently separating the metal oxide-loaded zeolite Beta by processes such as washing, drying, calcining, etc.

In one or more embodiments, the metal oxide-loaded zeolite Beta may comprise one or more metal oxides chosen from iron oxide, lanthanum oxide, and cerium oxide.

According to one or more embodiments, the metal oxide-loaded zeolite Beta presently disclosed may be incorporated into a catalyst. The catalyst may be utilized as a catalyst in the processing of waste plastics or plastic-derived oils, as described herein in detail.

In one or more embodiments, the catalyst may comprise the presently described metal oxide-loaded zeolite Beta and one or more metal oxide support materials.

In one or more embodiments, the metal oxide-loaded zeolite Beta may comprise from 0.1 wt. % to 5 wt. % of iron oxide, based on the total weight of the catalyst. In one or more embodiments, the metal oxide-loaded zeolite Beta may comprise from 0.1 wt. % to 4 wt. %, from 0.1 wt. % to 3 wt. %, from 0.1 wt. % to 2 wt. %, from 0.1 wt. % to 1.5 wt. %, from 0.5 wt. % to 5 wt. %, from 0.5 wt. % to 4 wt. %, from 0.5 wt. % to 3 wt. %, from 0.5 wt. % to 2 wt. %, or from 0.5 wt. % to 1.5 wt. % iron oxide, based on the total weight of the catalyst.

In one or more embodiments, the metal oxide-loaded zeolite Beta may comprise from 0.1 wt. % to 5 wt. % of lanthanum oxide, based on the total weight of the catalyst. In one or more embodiments, the metal oxide-loaded zeolite Beta may comprise from 0.1 wt. % to 4 wt. %, from 0.1 wt. % to 3 wt. %, from 0.1 wt. % to 2 wt. %, from 0.1 wt. % to 1.5 wt. %, from 0.5 wt. % to 5 wt. %, from 0.5 wt. % to 4 wt. %, from 0.5 wt. % to 3 wt. %, from 0.5 wt. % to 2 wt. %, or from 0.5 wt. % to 1.5 wt. % lanthanum oxide, based on the total weight of the catalyst.

In one or more embodiments, the metal oxide-loaded zeolite Beta may comprise from 0.1 wt. % to 5 wt. % of cerium oxide, based on the total weight of the catalyst. In one or more embodiments, the metal oxide-loaded zeolite Beta may comprise from 0.1 wt. % to 4 wt. %, from 0.1 wt. % to 3 wt. %, from 0.1 wt. % to 2 wt. %, from 0.1 wt. % to 1.5 wt. %, from 0.5 wt. % to 5 wt. %, from 0.5 wt. % to 4 wt. %, from 0.5 wt. % to 3 wt. %, from 0.5 wt. % to 2 wt. %, or from 0.5 wt. % to 1.5 wt. % cerium oxide, based on the total weight of the catalyst.

In one or more embodiments, the metal oxide-loaded zeolite Beta may comprise from 0.1 wt. % to 5 wt. % of iron oxide, from 0.1 wt. % to 5 wt. % of lanthanum oxide, and from 0.1 wt. % to 5 wt. % of cerium oxide, based on the total weight of the catalyst. In one or more embodiments, the metal oxide-loaded zeolite Beta may comprise from 0.5 wt. % to 1.5 wt. % of iron oxide, from 0.5 wt. % to 1.5 wt. % of lanthanum oxide, and from 0.5 wt. % to 1.5 wt. % of cerium oxide, based on the total weight of the catalyst.

In one or more embodiments, the metal oxide-loaded zeolite Beta may comprise from 1 wt. % to 10 wt. % of P₂O₅, based on the total weight of the catalyst. Without intending to be bound by any particular theory, it is believed that utilizing a catalyst comprising the metal oxide-loaded zeolite Beta that comprises phosphorous oxide may reduce acid strength of the catalyst, improve catalyst stability, and/or increase selectivity. In one or more embodiments, the metal oxide-loaded zeolite Beta may comprise from 1 wt. % to 10 wt. %, from 1 wt. % to 9 wt. %, from 1 wt. % to 8 wt. %, from 1 wt. % to 7 wt. %, from 1 wt. % to 6 wt. %, from 1 wt. % to 5 wt. %, from 1 wt. % to 4 wt. %, from 2 wt. % to 10 wt. %, from 2 wt. % to 9 wt. %, from 2 wt. % to 8 wt. %, from 2 wt. % to 7 wt. %, from 2 wt. % to 6 wt. %, from 2 wt. % to 5 wt. %, from 2 wt. % to 4 wt. %, or from 3 wt. % to 4 wt. % P₂O₅, based on the total weight of the catalyst.

In one or more embodiments, the catalyst may comprise from 10 wt. % to 70 wt. % of the metal oxide-loaded zeolite Beta, based on a total weight of the catalyst. For example, in embodiments, the catalyst may comprise greater than or equal to 10 wt. % and less than or equal to 70 wt. %, less than or equal to 60 wt. %, less than or equal to 50 wt. %, less than or equal to 40 wt. %, or less than or equal to 30 wt. %, greater than or equal to 20 wt. % and less than or equal to 70 wt. %, less than or equal to 60 wt. %, less than or equal to 50 wt. %, less than or equal to 40 wt. %, or less than or equal to 30 wt. %, greater than or equal to 30 wt. % and less than or equal to 70 wt. %, less than or equal to 60 wt. %, less than or equal to 50 wt. %, or less than or equal to 40 wt. % of the metal oxide-loaded zeolite Beta.

In embodiments, the catalyst can include one or more binder materials, such as alumina-containing compounds or silica-containing compounds (including compounds containing alumina and silica). As used in the present disclosure, “binder materials” refer to materials that serve to “glue” or otherwise hold components of the catalyst. Binder materials can be included to improve the attrition resistance of the catalyst. The binders can comprise alumina (such as amorphous alumina), silica-alumina (such as amorphous silica-alumina), or silica (such as amorphous silica).

In embodiments, the catalyst can include the one or more binders in an amount of from 5 wt. % to 30 wt. % based on the total weight of the catalyst. In embodiments, the catalyst can include the one or more binders in an amount of from 5 wt. % to 25 wt. %, from 5 wt. % to 20 wt. %, from 5 wt. % to 15 wt. %, from 5 wt. % to 10 wt. %, from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, from 20 wt. % to 25 wt. %, or from 25 wt. % to 30 wt. % based on the total weight of the catalyst composition.

In embodiments, the catalyst can include an alumina binder in an amount of from 2 wt. % to 20 wt. % based on the total weight of the catalyst. In embodiments, the catalyst can include the alumina binder in an amount of from 2 wt. % to 15 wt. %, from 2 wt. % to 10 wt. %, from 5 wt. % to 20 wt. %, from 5 wt. % to 15 wt. %, from 5 wt. % to 10 wt. %, or from 7 wt. % to 9 wt. % based on the total weight of the catalyst.

In embodiments, the catalyst may include one or more matrix materials, which may include one or more clay materials, such as but not limited to Kaolin clay. Without being bound by any particular theory, it is believed that the matrix materials of the catalyst can serve both physical and catalytic functions. Physical functions can include providing particle integrity and attrition resistance, acting as a heat transfer medium, and providing a porous structure to allow diffusion of hydrocarbons into and out of the catalyst microspheres. The matrix materials can also affect catalyst selectivity, product quality, and resistance to poisons. The matrix materials may tend to exert its strongest influence on overall catalytic properties for those reactions that directly involve relatively large molecules.

In embodiments, the matrix materials can include Kaolin clay. As used in the present disclosure, “Kaolin clay” refers to a clay material that has a relatively large amount (such as at least about 50 wt. %, at least 60 wt. %, at least 70 wt. %, at least 80 wt. %, at least 90 wt. %, or at least 95 wt. %) of kaolinite, which can be represented by the chemical formula Al₂Si₂O₅(OH)₄. In additional embodiments, the matrix material may comprise other clay materials. In embodiments, the catalyst can include one or more matrix materials in an amount of from 30 wt. % to 60 wt. % based on the total weight of each of the catalyst. In embodiments, the catalyst can include from 30 wt. % to 55 wt. %, from 30 wt. % to 50 wt. %, from 30 wt. % to 45 wt. %, from 30 wt. % to 40 wt. %, from 30 wt. % to 35 wt. %, from 35 wt. % to 60 wt. %, from 35 wt. % to 55 wt. %, from 35 wt. % to 50 wt. %, from 35 wt. % to 45 wt. %, from 35 wt. % to 40 wt. %, from 40 wt. % to 60 wt. %, from 40 wt. % to 55 wt. %, from 40 wt. % to 50 wt. %, from 40 wt. % to 45 wt. %, from 45 wt. % to 60 wt. %, from 45 wt. % to 55 wt. %, from 45 wt. % to 50 wt. %, from 50 wt. % to 60 wt. %, from 50 wt. % to 55 wt. %, or from 55 wt. % to 60 wt. % matrix materials based on the total weight of the catalyst.

According to one or more embodiments, the entirety of the catalyst that is utilized in the fluid catalytic cracking reactor unit 100 may be the catalyst that comprises the metal oxide-loaded zeolite Beta described herein. That is, one or more embodiments, no other active cracking catalytic components are included in the totality of the catalyst, such as other zeolites. In additional embodiments, the catalyst that comprises the metal oxide-loaded zeolite Beta described herein may be used as a portion of the total catalyst in the fluid catalytic cracking reactor unit 100.

In one or more embodiments, the catalyst can be in the form of shaped microparticles, such as microspheres. As used in the present disclosure, “microparticles” refer to particles having an average particle size of from 0.1 microns and 100 microns. The size of a microparticle refers to the maximum length of a particle from one side to another, measured along the longest distance of the microparticle. For example, a spherically shaped microparticle has a size equal to its diameter, or a rectangular prism shaped microparticle has a maximum length equal to the hypotenuse stretching from opposite corners.

The catalysts described herein can be formed by a variety of processes. According to one embodiment, a matrix material, such as kaolin clay, can be mixed with a fluid such as water to form a slurry, and the metal oxide-loaded zeolite Beta can be separately mixed with a fluid such as water to form a slurry. The matrix material slurry and the metal oxide-loaded zeolite Beta slurry can be combined under stirring. Separately, another slurry can be formed by combining the one or more binders with a fluid such as water. The binder slurry can then be combined with the slurry containing the metal oxide-loaded zeolite Beta and matrix material to form a final slurry. The final slurry can then be dried, for example by spraying, and then calcined to produce the microparticles of the cracking catalyst.

As described herein, methods of processing the plastic-derived oil may comprise contacting the plastic-derived oil with the catalyst to crack the plastic-derived oil to form a hydrocarbon product. In one or more embodiments, the hydrocarbon product comprises butenes and propylene. In one or more embodiments, the hydrocarbon product may comprise at least 20 wt. % of the combination of the butenes and the propylene, based on the total weight of the hydrocarbon product. For example, in one or more embodiments, the hydrocarbon product may comprise at least 25 wt. %, or at least 30 wt. % of the combination of the butenes and the propylene, based on the total weight of the hydrocarbon product. In one or more embodiments, the hydrocarbon product may comprise at least 10 wt. % of the butenes, based on the total weight of the hydrocarbon product. For example, in one or more embodiments, the hydrocarbon product may comprise at least 11 wt. %, at least 12 wt. %, at least 13 wt. %, at least 14 wt. %, at least 15 wt. %, or at least 16 wt. % of the butenes, based on the total weight of the hydrocarbon product. In one or more embodiments, the hydrocarbon product may comprise at least 10 wt. % of propylene, based on the total weight of the hydrocarbon product. For example, in one or more embodiments, the hydrocarbon product may comprise at least 11 wt. %, at least 12 wt. %, at least 13 wt. %, at least 14 wt. %, at least 15 wt. %, or at least 16 wt. % of propylene, based on the total weight of the hydrocarbon product.

According to one or more embodiments, the fluid catalytic cracking reactor unit 100 may be configured to contact the plastic-derived oil 110 with the catalyst at a temperature of from 500° C. to 700° C., such as from 500° C. to 650° C., from 500° C. to 600° C., from 500° C. to 550° C., from 550° C. to 700° C., from 600° C. to 700° C., or from 650° C. to 700° C. The fluid catalytic cracking reactor unit 100 may be configured to contact the plastic-derived oil 110 with the catalyst at a pressure of from 101 kilopascals (kPa) to 303 kPa, or at atmospheric pressure (about 101 kPa). In embodiments, the fluid catalytic cracking reactor unit 100 may be operable to contact the plastic-derived oil 110 with the catalyst at a catalyst-to-oil weight ratio of from 4 to 40, such as from 10 to 30. The catalyst-to-oil weight ratio in the fluid catalytic cracking reactor unit 100 may be equal to an average amount of catalyst present in the reaction zone 134 of the fluid catalytic cracking reactor unit 100 to the average amount of plastic-derived oil present in the reaction zone 134 of the fluid catalytic cracking reactor unit 100 during steady state operation of the fluid catalytic cracking reactor unit 100.

According to one or more embodiments, the hydrocarbon product 120 may be upgraded and richer in higher-value chemicals than the plastic-derived oil 110. For example, the hydrocarbon product 120 may comprise butenes and/or propylene. For example, in some embodiments, the hydrocarbon product 120 may comprise at least 5 wt. %, at least 10 wt. %, at least 15 wt. %, at least 20 wt. %, at least 25 wt. %, or even at least 30 wt. % of the combination of butenes and propylene. In some embodiments, the plastic-derived oil 110 may comprise less than 5 wt. %, less than 3 wt. %, or even less than 1 wt. % of the combination of butenes and propylene, and the formed hydrocarbon product 120 may comprise at least 10 wt. %, at least 15 wt. %, at least 20 wt. %, at least 25 wt. %, or even at least 30 wt. % of the combination of butenes and propylene.

In some embodiments, the amount of lower-value chemicals such as jet fuel, diesel, and heavy compounds boiling at greater than 343° C. may be less than in conventional cracking embodiments. For example, the in some embodiments, the hydrocarbon product 120 may comprise less than 50 wt. %, less than 45 wt. %, less than 35 wt. %, less than 30 wt. %, or even less than 25 wt. % of the combination of jet fuel, diesel, and heavy compounds boiling at greater than 343° C.

According to additional embodiments described herein, waste plastic may be processed to form the hydrocarbon product. Such methods to process waste plastic may include producing plastic-derived oil from waste plastic, and subsequently contacting the plastic-derived oil with the catalysts described herein to form the hydrocarbon product. As described herein, according to one or more embodiments, producing of the plastic-derived oil from the waste plastic may comprises pyrolizing the waste plastic, and may further comprise a dehalogenation procedure.

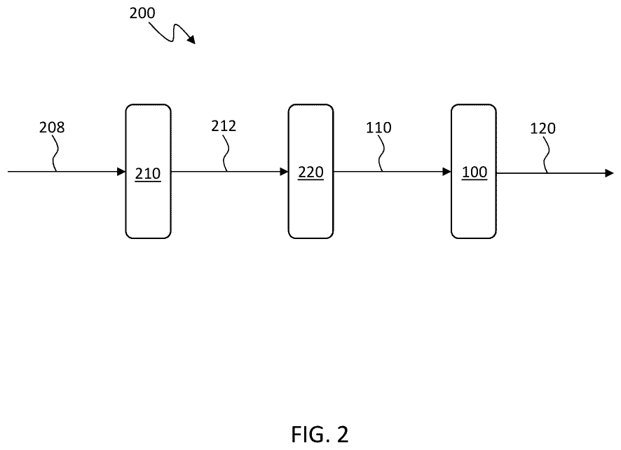

Now referring to FIG. 2, a system 200 for processing waste plastic into hydrocarbon product is schematically depicts, where the presently disclosed methods will now be described in the context of this example system 200. The system 200 may include a dehalogenation unit 210, a pyrolysis unit 220, and the FCC reactor unit 100 depicted in FIG. 1. Generally, the waste plastic 208 is passed into the system 200 and hydrocarbon product 120 is passed out of the system, which may be further treated such as by separation or downstream processing.

According to embodiments, the dehalogenation unit 210 may be operable to melt solid waste plastic 208 to produce a liquefied plastic stream 212. The liquefied plastic stream 212 may be passed to the pyrolysis unit 220 downstream of the dehalogenation unit 210. The pyrolysis unit 220 may be configured to subject the liquefied plastic stream 212 to pyrolysis to produce the plastic-derived oil 110. The processes disclosed herein may include producing the plastic-derived oil 110 from a solid waste plastic 208 by liquefying the solid waste plastic 208 in the dehalogenation unit 210 to produce a liquefied plastic stream 212, passing the liquefied plastic stream 212 to the pyrolysis unit 220, and subjecting the liquefied plastic stream 212 to pyrolysis to produce the plastic-derived oil stream 102.

The solid waste plastic 208 supplied to the dehalogenation unit 210 may comprise a plastic feedstock including mixed solid waste plastics of differing compositions. The solid waste plastic 208 may be a mixture of plastics from various polymer families. In embodiments, the solid waste plastic 208 may comprise plastics representative of one or more of the polymer families, such as but not limited to olefins, carbonates, aromatic polymers, sulfones, fluorinated hydrocarbon polymers, chlorinated hydrocarbon polymers, acrylonitriles, or combinations of these families of polymers. In embodiments, the mixed waste plastics 208 may include polyethylene (PE), polypropylene (PP), diphenylcarbonate, polystyrene (PS), polyether sulfone, polyfluoroethylene (PTFE), polyvinyl chloride (PVC), polyacrylonitrile (PAN), other polymers, or combinations of these. In embodiments, solid waste plastics 208 may be a mixture of high density polyethylene (HDPE, for example, a density of about 0.93 to 0.97 grams per cubic centimeter (g/cm³), low density polyethylene (LDPE, for example, about 0.910 g/cm³ to 0.940 g/cm³), polypropylene (PP), linear low density polyethylene (LLDPE), polystyrene (PS), polyvinyl chloride (PVC), polyethylene terephthalate (PET), or combinations of these polymers. In embodiments, the solid waste plastics 208 may include one or more chlorinated hydrocarbons, such as PVC. The plastics of the solid waste plastics 208 may be natural, synthetic, or semi-synthetic polymers. Utilization of the solid waste plastics 208 comprising a mixture of different types of plastics and polymers may allow for recycling of solid plastics without necessitating fine sorting of the plastics into different types.

The solid waste plastics 208 may be provided in a variety of different forms. In embodiments, the solid waste plastics 208 may be in the form of a powder in smaller scale operations. In embodiments, the solid waste plastics 208 may be in the form of pellets, such as pellets with a particle size of from 1 to 5 millimeter (mm) for larger scale operations. In embodiments, the solid waste plastics 208 may be provided as chopped or ground waste plastics. In embodiments, the system 200 may include a plastic grinding unit (not shown) upstream of the dehalogenation reactor, where the plastic grinding unit may be operable to grind plastic articles into smaller pieces to produce the solid waste plastics 208. In embodiments, the solid waste plastics 208 may comprise waste plastic, manufacturing off-spec product, new plastic products, unused plastic products, or combinations of these.

The dehalogenation unit 210 may be in fluid communication with the solid waste plastics 208 and may be operable to raise the temperature of the solid waste plastics 208 to a temperature from 250° C. and 350° C., such as from 250° C. to 300° C., to melt the plastics and generate the liquefied plastic stream 212. When the solid waste plastics 208 include halogenated plastics, such as but not limited to PVC, melting the plastics may release some hydrogen halides, such as HCl. The dehalogenation unit 210 may also be operable to scrub HCl and other halogen halides released during melting of the solid waste plastics 208. Removal of some of the chlorine, fluorine, or other halides from the solid waste plastic 208 may reduce the concentration of halides in the liquefied plastic stream 212. As a result, the liquefied plastic stream 212 may have a reduced concentration of chlorine and other halogens compared to the solid waste plastic 208. Reducing the concentration of organic halide compounds in the liquefied plastic stream 212 may reduce corrosion problems in the downstream pyrolysis unit 220. However, the liquefied plastic stream 212 may still contain halogen-containing organic compounds and other contaminants.

In embodiments, the dehalogenation reactor 10 may be operable to increase the temperature of the solid waste plastic 208 to a temperature of from 250° C. to 350 to melt the solid waste plastic 208 and remove at least a portion of the chlorine and other halogens from the resulting liquefied plastic stream 212. In embodiments, the dehalogenation reactor 10 may be operable to increase the temperature of the solid waste plastic 208 to a temperature of from 250° C. to 325° C., from 250° C. to 300° C., from 275° C. to 350° C., from 275° C. to 325° C., or from 300° C. to 350° C. The temperature of the dehalogenation reactor 10 may be controlled to remove HCl without cracking a substantial number of C—H or C—C bonds.

In embodiments, the dehalogenation unit 210 may include a melting reactor and an acid gas scrubber downstream of the melting reactor. In embodiments, a single unit forming the dehalogenation unit 210 may achieve both melting of the plastic solid plastic and scrubbing to remove hydrogen halides. Organic halide compounds not released during dehalogenation in the dehalogenation unit 210 may be passed onward in the liquefied plastic stream 212 to the pyrolysis unit 220.

Referring still to FIG. 2, the pyrolysis unit 220 may be disposed downstream of the dehalogenation unit 210 and in fluid communication with the liquefied plastic stream 212 discharged from the dehalogenation unit 210. The pyrolysis unit 220 may be operable to increase the temperature of the liquefied plastic stream 212 to a temperature of from 300° C. to 1000° C., such as from 350° C. to 1000° C., in an anaerobic environment (e.g., less than 0.1 mol. % O₂, or free of O₂), to convert the liquefied plastic stream 212 to the plastic-derived oil 110. In particular, the pyrolysis of the liquefied plastic stream 212 in the pyrolysis unit 220 may cause at least a portion of the long chain polymers in the liquefied plastic stream 212 to break apart into smaller fragments comprising organic compounds having smaller average molecular weight compared to the long chain polymers in the liquefied plastic stream 212.

The specific reactor used as the pyrolysis unit 220 can be of different types and are not limited for the purposes of the present disclosure. Typical reactor types that can be used to serve the function of the pyrolysis unit 220 can include but are not limited to tank reactors, rotary kilns, packed catalyst bed reactors, bubbling bed reactors, or other types of reactors. In embodiments, the pyrolysis of the liquefied plastic stream 212 in the pyrolysis unit 220 may be performed in the presence or absence of a pyrolysis catalyst at a temperature of from 300° C. to 1000° C. or from 350° C. to 1000° C. In embodiments, the pyrolysis unit 220 may operate at a low severity at a temperature less than or equal to 450° C. or at a high severity at a temperature greater than 450° C. In embodiments, the pyrolysis unit 220 may be operated at a temperature of from 400° C. to 600° C., from 400° C. to 500° C., from 400° C. to 450° C., from 450° C. to 500° C., or from 425° C. to 475° C. In embodiments, the pyrolysis unit 220 may be operated at a pressure in the range of 1 bar to 100 bars (100 kilopascals (kPa) to 10,000 kPa), from 1 bar to 50 bars (100 kPa to 5000 kPa), from 1 bar to 25 bars (1 kPa to 2500 kPa), or from 1 bar to 10 bars (1 kPa to 1000 kPa). Further, in various embodiments, the residence time of the liquefied plastic stream 212 in the pyrolysis unit 220 may be from 1 second to 3600 seconds, from 60 seconds to 1800 seconds, or from 60 seconds to 900 seconds. The plastic-derived oil 110 may be passed out of the pyrolysis unit 220.

### Examples

The various embodiments of the methods of the present disclosure will be further clarified by the following examples. The examples are illustrative in nature, and should not be understood to limit the subject matter of the present disclosure.

A catalyst comprising a metal oxide-loaded zeolite Beta comprising zeolite Beta particles having a size of less than 100 nm and one or more metal oxides chosen from iron oxide, lanthanum oxide, and cerium oxide was prepared as follows: 352.11 g of kaolin clay was formed into a slurry with 821.6 g of deionized water to form a kaolin slurry. Separately, 242.48 g of zeolite Beta (CP814E obtained from Zeolyst International) was formed into a slurry with 258.52 g of deionized water to produce a zeolite slurry. While the zeolite slurry was stirred, 32.59 g of diammonium phosphate was added gradually to the zeolite slurry. The zeolite slurry was stirred for another 15 min, after which 13.29 g of lanthanum nitrate hexahydrate, 25.14 g of iron (III) nitrate nanohydrate, and 12.59 g of cerium (III) nitrate hexahydratecerium were added and the stirring was continued for another 15 min to form an impregnated zeolite slurry. The impregnated zeolite slurry was added to the kaolin slurry and stirred for at 5 min to form a kaolin-zeolite slurry. In a separate step, 138.89 g of Catapal B was formed into a slurry with 324.07 g of deionized water to form a Catapal B slurry. The Catapal B slurry was peptized with 8.24 g of formic acid (85 wt % concentration) to form a peptized alumina gel. The peptized alumina gel was added to the kaolin-zeolite slurry and stirred vigorously for 1 h. After stirring, the resulting slurry was ball milled, sieved, and then spray dried. The spray dried catalyst was then calcined at 550° C. for 6 h to form the catalyst comprising a metal oxide-loaded zeolite Beta. The catalyst included a concentration of about 3.5 wt. % phosphorous oxide, about 1 wt. % iron oxide, about 1 wt. % lanthanum oxide, and about 1 wt. % cerium oxide, based on the total weight of the catalyst. Properties of the zeolite Beta (CP814E) are summarized in Table 2.

TABLE 2

| Property | |
|---|---|
| Silica to Alumina Ratio | 25 |
| Total surface area, m2/g | 624.22 |
| Micropore surface area, m2/g | 426.23 |
| Mesopore surface area, m2/g | 197.99 |
| Total pore volume, ml/g | 0.97 |
| Micro pore volume, ml/g | 0.80 |
| Mesopore volume, ml/g | 0.17 |
| Average Pore size, nm | 0.73 |

A plastic derived oil produced from solid waste plastic was catalytically cracked over the catalyst comprising the metal oxide-loaded zeolite Beta according to an Advanced Cracking Evaluation (ACE) test procedure to show the products produced through catalytically cracking a plastic derived oil. As a comparison, the plastic derived oil was also cracked over E-cat. The ACE tests were conducted using a micro-activity cracking testing (MAT) unit. The MAT unit and ACE testing process is described more in detail in U.S. Pat. No. 6,069,012. The ACE testing was performed with a catalyst to oil weight ratio of 8, and the catalytic cracking was conducted at temperatures of 550° C., 575° C., and 600° C.

For each experimental run, the reactor effluent was passed out of the MAT unit and sent to a gas/liquid separator, which separated the reactor effluent into a liquid product stream and a gaseous product stream. The gaseous product stream was analyzed by an online gas chromatography system (Agilent 7890 gas chromatograph) equipped with both FID and TCD detectors. The liquid product stream was analyzed according to the offline analytical test methods. In particular, the liquid product stream was analyzed by simulated distillation according to test method EN 15199-2 using the Agilent 7890 gas chromatograph. For the simulated distillation, the analysis was conducted for five distillation fractions: (1) light hydrocarbon gases having 1-4 carbon atoms; (2) a light naphtha fraction having a boiling point range of from C5 (boiling point temperature >25° C.) to 150° C.; (3) a jet fuel fraction having a boiling point range of from 150° C. to 300° C.; (4) a diesel fraction having a boiling point range of from 300° C. to 343° C.; and (5) a heavy distillate fraction having boiling point temperatures greater than 343° C. The light hydrocarbon gases were further classified into fuel gas (hydrogen and methane), C2-C4 paraffins, ethylene, propylene, and butenes. Coke is quantified after passing an air stream through the MAT unit at high temperatures to burn the coke into a mixture of carbon monoxide, carbon dioxide, and water, and then passing the combustion gases through a calibrated infrared analyzer. The composition of the plastic derived oil and the reaction products formed using the catalyst comprising the metal oxide-loaded zeolite Beta are provided in Table 3. The composition of the plastic derived oil and the reaction products formed using the comparative E-cat are provided in Table 4.

TABLE 3

| | Plastic | | | |
|---|---|---|---|---|
| Constituent | derived oil | 1 | 2 | 3 |
| Rxn Temperature (° C.) | N/A | 550 | 575 | 600 |
| Fuel Gas (wt. %) | — | 0.7 | 1.0 | 1.8 |
| C2-C4 paraffin (wt. %) | — | 11.6 | 11.7 | 11.0 |
| Ethylene (wt. %) | — | 1.3 | 1.7 | 2.5 |
| Propylene (wt. %) | — | 12.1 | 13.8 | 15.8 |
| Butenes (wt. %) | — | 12.9 | 14.2 | 15.4 |
| Light Naphtha (wt. %) | 23.8 | 42.0 | 39.6 | 37.0 |
| Jet fuel | 49.7 | 15.6 | 14.0 | 12.8 |
| Diesel (wt. %) | 15.2 | 1.4 | 1.4 | 1.3 |
| Heavy Distillate (wt. %) | 11.3 | 1.2 | 1.1 | 0.9 |
| Coke (wt. %) | — | 1.0 | 1.4 | 1.5 |

TABLE 4

| | Plastic | | | |
|---|---|---|---|---|
| Constituent | derived oil | 1 | 2 | 3 |
| Rxn Temperature (° C.) | N/A | 0.7 | 1.0 | 1.8 |
| Fuel Gas (wt. %) | — | 11.6 | 11.7 | 11.0 |
| C2-C4 paraffin (wt. %) | — | 1.3 | 1.7 | 2.5 |
| Ethylene (wt. %) | — | 12.1 | 13.8 | 15.8 |
| Propylene (wt. %) | — | 12.9 | 14.2 | 15.4 |
| Butenes (wt. %) | — | 42.0 | 39.6 | 37.0 |
| Light Naphtha (wt. %) | 23.8 | 15.6 | 14.0 | 12.8 |
| Jet fuel | 49.7 | 1.4 | 1.4 | 1.3 |
| Diesel (wt. %) | 15.2 | 1.2 | 1.1 | 0.9 |
| Heavy Distillate (wt. %) | 11.3 | 1.0 | 1.4 | 1.5 |
| Coke (wt. %) | — | 0.7 | 1.0 | 1.8 |

Referring to Table 3 and Table 4, the plastic derived oil is a suitable feed for fluidized catalytic cracking, where the plastic derived oil can be converted to generate circular chemicals such as ethylene, propylene, and butenes, as well as low carbon footprint fuels (naphtha). As shown in Table 3 and Table 4, the catalyst used in this disclosure, resulted in increased production of propylene and butenes compared to a conventional catalyst in the catalytic cracking of plastic derived oil.

A first aspect of the present disclosure is directed to a method for processing a plastic-derived oil, the method comprising: contacting the plastic-derived oil with a catalyst to crack the plastic-derived oil to form a hydrocarbon product, wherein: the catalyst comprises metal oxide-loaded zeolite Beta comprising: zeolite Beta particles having a size of less than 100 nm; and one or more metal oxides chosen from iron oxide, lanthanum oxide, and cerium oxide, wherein the one or more metal oxides are disposed on the zeolite Beta particles.

A second aspect of the present disclosure may include the first aspect, wherein the metal oxide-loaded zeolite Beta comprises iron oxide, lanthanum oxide, and cerium oxide.

A third aspect of the present disclosure may include the second aspect, wherein the metal oxide-loaded zeolite Beta comprises from 0.1 to 5 wt. % iron oxide, from 0.1 to 5 wt. % lanthanum oxide, and from 0.1 to 5 wt. % cerium oxide, based on the total weight of the catalyst.

A fourth aspect of the present disclosure may include either one of the second aspect or third aspect, wherein the metal oxide-loaded zeolite Beta comprises from 0.5 to 1.5 wt. % iron oxide, from 0.5 to 1.5 wt. % lanthanum oxide, and from 0.5 to 1.5 wt. % cerium oxide, based on the total weight of the catalyst.

A fifth aspect of the present disclosure may include any one of the first through fourth aspects, wherein the metal oxide-loaded zeolite Beta comprises from 1 wt. % to 10 wt. % phosphorous oxide, based on the total weight of the catalyst.

A sixth aspect of the present disclosure may include any one of the first through fifth aspects, wherein the catalyst comprises from 10 wt. % to 65 wt. % of the metal oxide-loaded zeolite Beta, based on the total weight of the catalyst.

A seventh aspect of the present disclosure may include the sixth aspect, wherein the catalyst comprises: from 5 wt. % to 30 wt. % of one or more binders; and from 30 wt. % to 60 wt. % of one or more matrix materials.

An eighth aspect of the present disclosure may include any one of the first through seventh aspects, wherein the plastic-derived oil comprises: from 5 wt. % to 50 wt. % of hydrocarbons having a boiling point of less than 150° C.; from 25 wt. % to 75 wt. % of hydrocarbons having a boiling point of from 150° C. to 300° C.; from 5 wt. % to 30 wt. % of hydrocarbons having a boiling point of from 300° C. to 343° C.; and from 0 wt. % to 25 wt. % of hydrocarbons having a boiling point of greater than 343° C.

A ninth aspect of the present disclosure may include any one of the first through eighth aspects, wherein the plastic-derived oil comprises: from 20 wt. % to 30 wt. % of hydrocarbons having a boiling point of less than 150° C.; from 45 wt. % to 55 wt. % of hydrocarbons having a boiling point of from 150° C. to 300° C.; from 10 wt. % to 20 wt. % of hydrocarbons having a boiling point of from 300° C. to 343° C.; and from 5 wt. % to 15 wt. % of hydrocarbons having a boiling point of greater than 343° C.

A tenth aspect of the present disclosure may include any one of the first through ninth aspects, wherein the catalyst is fluidized while contacting the hydrocarbon feed.

An eleventh aspect of the present disclosure may include any one of the first through tenth aspects, wherein the catalyst is contacted with the plastic-derived oil in a fluidized catalytic cracking reactor unit operating at a temperature of from 500° C. to 700° C.

A twelfth aspect of the present disclosure may include any one of the first through eleventh aspects, wherein the hydrocarbon product comprises butenes and propylene.

A thirteenth aspect of the present disclosure may include any one of the first through twelfth aspects, wherein the hydrocarbon product comprises 20 wt. % or greater of the combination of butenes and propylene.

A fourteenth aspect of the present disclosure is directed to a method for processing waste plastic, the method comprising: producing plastic-derived oil from the waste plastic; and contacting the plastic-derived oil with a catalyst to form a hydrocarbon product, wherein the catalyst comprises metal oxide-loaded zeolite Beta comprising: zeolite Beta particles having a size of less than 100 nm; and one or more metal oxides chosen from iron oxide, lanthanum oxide, and cerium oxide, wherein the one or more metal oxides are disposed on the zeolite Beta particles.

A fifteenth aspect of the present disclosure may include the fourteenth aspect, wherein the producing of the plastic-derived oil from the waste plastic comprises pyrolizing the waste plastic.

A sixteenth aspect of the present disclosure may include the fifteenth aspect, wherein the pyrolizing of the waste plastic is at temperature of from 300° C. to 1000° C.

A seventeenth aspect of the present disclosure may include either one of the fifteenth or sixteenth aspects, wherein the pyrolizing is in an anaerobic environment.

An eighteenth aspect of the present disclosure may include any one of the fourteenth through seventeenth aspects, wherein the producing of the plastic-derived oil from the waste plastic further comprise a dehalogenation procedure.

A nineteenth aspect of the present disclosure may include any one of the fourteenth through eighteenth aspects, wherein the metal oxide-loaded zeolite Beta comprises iron oxide, lanthanum oxide, and cerium oxide.

A twentieth aspect of the present disclosure may include any one of the fourteenth through nineteenth aspects, wherein the metal oxide-loaded zeolite Beta comprises from 1 wt. % to 10 wt. % phosphorous oxide, based on the total weight of the catalyst.

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “hydrotreated effluent stream” passing from a first system component to a second system component should be understood to equivalently disclose “propylene” passing from a first system component to a second system component, and the like.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

It is also noted that recitations herein of “at least” followed by a quantitative value should be understood as being equivalent to “greater than or equal to” the quantitative value.

What is claimed is:

1. A method for processing a plastic-derived oil, the method comprising:
contacting the plastic-derived oil with a catalyst to crack the plastic-derived oil to form a hydrocarbon product, wherein:
the catalyst comprises metal oxide-loaded zeolite Beta comprising:
zeolite Beta particles having a size of less than 100 nm; and
one or more metal oxides chosen from iron oxide, lanthanum oxide, and cerium oxide, wherein the one or more metal oxides are disposed on the zeolite Beta particles.

2. The method of claim 1, wherein the metal oxide-loaded zeolite Beta comprises iron oxide, lanthanum oxide, and cerium oxide.

3. The method of claim 2, wherein the metal oxide-loaded zeolite Beta comprises from 0.1 to 5 wt. % iron oxide, from 0.1 to 5 wt. % lanthanum oxide, and from 0.1 to 5 wt. % cerium oxide, based on the total weight of the catalyst.

4. The method of claim 2, wherein the metal oxide-loaded zeolite Beta comprises from 0.5 to 1.5 wt. % iron oxide, from 0.5 to 1.5 wt. % lanthanum oxide, and from 0.5 to 1.5 wt. % cerium oxide, based on the total weight of the catalyst.

5. The method of claim 1, wherein the metal oxide-loaded zeolite Beta comprises from 1 wt. % to 10 wt. % phosphorous oxide, based on the total weight of the catalyst.

6. The method of claim 1, wherein the catalyst comprises from 10 wt. % to 65 wt. % of the metal oxide-loaded zeolite Beta, based on the total weight of the catalyst.

7. The method of claim 6, wherein the catalyst comprises:
from 5 wt. % to 30 wt. % of one or more binders; and
from 30 wt. % to 60 wt. % of one or more matrix materials.

8. The method of claim 1, wherein the plastic-derived oil comprises:
from 5 wt. % to 50 wt. % of hydrocarbons having a boiling point of less than 150° C.;
from 25 wt. % to 75 wt. % of hydrocarbons having a boiling point of from 150° C. to 300° C.;
from 5 wt. % to 30 wt. % of hydrocarbons having a boiling point of from 300° C. to 343° C.; and
from 0 wt. % to 25 wt. % of hydrocarbons having a boiling point of greater than 343° C.

9. The method of claim 1, wherein the plastic-derived oil comprises:
from 20 wt. % to 30 wt. % of hydrocarbons having a boiling point of less than 150° C.;
from 45 wt. % to 55 wt. % of hydrocarbons having a boiling point of from 150° C. to 300° C.;
from 10 wt. % to 20 wt. % of hydrocarbons having a boiling point of from 300° C. to 343° C.; and
from 5 wt. % to 15 wt. % of hydrocarbons having a boiling point of greater than 343° C.

10. The method of claim 1, wherein the catalyst is fluidized while contacting the hydrocarbon feed.

11. The method of claim 1, wherein the catalyst is contacted with the plastic-derived oil in a fluidized catalytic cracking reactor unit operating at a temperature of from 500° C. to 700° C.

12. The method of claim 1, wherein the hydrocarbon product comprises butenes and propylene.

13. The method of claim 1, wherein the hydrocarbon product comprises 20 wt. % or greater of the combination of butenes and propylene.

14. A method for processing waste plastic, the method comprising:
producing plastic-derived oil from the waste plastic; and
contacting the plastic-derived oil with a catalyst to form a hydrocarbon product, wherein the catalyst comprises metal oxide-loaded zeolite Beta comprising:
zeolite Beta particles having a size of less than 100 nm; and
one or more metal oxides chosen from iron oxide, lanthanum oxide, and cerium oxide, wherein the one or more metal oxides are disposed on the zeolite Beta particles.

15. The method of claim 14, wherein the producing of the plastic-derived oil from the waste plastic comprises pyrolizing the waste plastic.

16. The method of claim 15, wherein the pyrolizing of the waste plastic is at temperature of from 300° C. to 1000° C.

17. The method of claim 15, wherein the pyrolizing is in an anaerobic environment.

18. The method of claim 14, wherein the producing of the plastic-derived oil from the waste plastic further comprise a dehalogenation procedure.

19. The method of claim 14, wherein the metal oxide-loaded zeolite Beta comprises iron oxide, lanthanum oxide, and cerium oxide.

20. The method of claim 14, wherein the metal oxide-loaded zeolite Beta comprises from 1 wt. % to 10 wt. % phosphorous oxide, based on the total weight of the catalyst.
